(19) United States
(12) Patent Application Publication
(10) Pub. No.: US 2021/0065145 A1
(43) Pub. Date: Mar. 4, 2021

(54) SYSTEMS AND METHODS FOR ACCEPTANCE OF PAYMENTS TO A BUSINESS DEMAND DEPOSIT ACCOUNT

(71) Applicant: JPMORGAN CHASE BANK, N.A., New York, NY (US)

(72) Inventors: Sumesh KAZA, San Francisco, CA (US); Ted HELLMAN, Fairfax, CA (US); Iqbal M. KHAN, Glenview, IL (US); Mizan MIAH, Wilmington, DE (US); Jasbir BANGA, Swedesboro, NJ (US); Ryan S. YODER, Tampa, FL (US); Jeff MADDOX, New York, NY (US)

(21) Appl. No.: 17/005,107

(22) Filed: Aug. 27, 2020

Related U.S. Application Data
(60) Provisional application No. 62/892,122, filed on Aug. 27, 2019.

(51) Int. Cl. G06Q 20/10; G06Q 40/02; G06Q 30/00; G06Q 20/32; G06Q 20/40; G06N 20/00; G06N 5/04

(52) U.S. Cl. CPC G06Q 20/108; G06Q 40/02; G06Q 30/0185; G06Q 20/3221; G06N 5/04; G06Q 20/3263; G06Q 20/4016; G06Q 20/405; G06N 20/00; G06Q 20/3223

(57) ABSTRACT

Systems and methods for acceptance of payments to a demand deposit account are disclosed. In one embodiment, in a backend for a financial institution comprising at least one computer processor, a method for accepting credit card payments at a demand deposit account (DDA) may include: (1) receiving a customer interaction from a mobile application; (2) determining if the customer is eligible for a credit card accepting service; (3) causing a payment acceptance interactive feature to be displayed in the mobile application; (4) enrolling the customer in the credit card accepting service; (5) linking the credit card accepting service to the customer's DDA; and (6) causing the mobile application to display an enrollment confirmation message.

### RELATED APPLICATIONS

This application claims priority to, and the benefit of, U.S. Provisional Patent Application Ser. No. 62/892,122 filed Aug. 27, 2019, the disclosure of which is hereby incorporated, by reference, in its entirety.

### BACKGROUND OF THE INVENTION

### 1. Field of the Invention

The present disclosure generally relates to systems and methods for acceptance of payments to a demand deposit account.

### 2. Description of the Related Art

In order for a small business to accept credit card payments, the business must sign up for a merchant account. This creates friction, as the small business may already have a demand deposit account (“DDA”) and may not want to have to open another account. In addition, from the perspective of many customers, the merchant account is simply a means to deposit funds into the DDA.

### SUMMARY OF THE INVENTION

Systems and methods for acceptance of payments to a demand deposit account are disclosed. In one embodiment, in a backend for a financial institution comprising at least one computer processor, a method for accepting credit card payments at a demand deposit account (DDA) may include: (1) receiving a customer interaction from a mobile application; (2) determining if the customer is eligible for a credit card accepting service; (3) causing a payment acceptance interactive feature to be displayed in the mobile application; (4) enrolling the customer in the credit card accepting service; (5) linking the credit card accepting service to the customer's DDA; and (6) causing the mobile application to display an enrollment confirmation message.

In one embodiment, the payment acceptance interactive feature may include a button.

In one embodiment, the method may further include receiving, from the mobile application, an indication that the payment acceptance interactive feature was selected; receiving, from the mobile application, payment information comprising a credit card number and a transaction amount; processing the payment information; and depositing the transaction amount to the customer's DDA.

In one embodiment, the credit card number may be received as an image.

In one embodiment, the credit card number may be received as an electronic file.

According to another embodiment, in an information processing apparatus comprising at least one computer processor, a method for integrated account opening may include: (1) receiving, from a prospective customer, a request to open a demand deposit account (DDA); (2) opening the DDA; (3) opening a non-DDA account for the prospective customer; (4) linking the non-DDA account to the DDA account; and (5) presenting information for the DDA and the non-DDA account in a mobile application.

In one embodiment, the method may further include verifying an identity of the customer.

In one embodiment, the non-DDA account may be inactive until it is used.

In one embodiment, the non-DDA account may include a merchant services account, a business card account, or a credit product.

In one embodiment, the non-DDA account may be opened in the background.

In one embodiment, the non-DDA account may be made available to the customer during an interaction with the DDA. In one embodiment, the interaction may be a deposit process.

In one embodiment, a type of non-DDA account may be identified by machine learning.

According to another embodiment, in an information processing apparatus comprising at least one computer processor, a method for integrated account management, may include: (1) receiving, from an online portal, a customer interaction with one of a plurality of customer accounts, the customer account integrated with each other; (2) generating an abstraction for transactions involving each account from a plurality of systems; (3) applying a rule to identify a feature to make available to the customer; and (4) presenting the feature to the customer in the online portal.

In one embodiment, two of the plurality of accounts may be serviced by different backend systems.

In one embodiment, the transactions may include at least one an underlying money movement, an underlying account, and a risk assessment.

In one embodiment, the method may further include applying machine learning to the abstractions to identify a product, feature, or function to make available to the customer.

In one embodiment, the machine learning may be further applied to customer clickstream data.

In one embodiment, the method may further include assessing a customer risk by applying a risk rule to the abstractions.

In one embodiment, the method may further include enforcing a transaction limit on a money movement based on the risk assessment.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for acceptance of payments to a demand deposit account according to an embodiment;

FIG. 2 depicts a method for acceptance of payments to a demand deposit account according to an embodiment;

FIG. 3 depicts system for account management of a business DDA according to an embodiment;

FIG. 4 depicts a method for account management of a business DDA according to an embodiment;

FIG. 5 depicts a method of enrolling a customer in a service to accept payment into the customer's DDA according to an embodiment; and

FIG. 6 depicts a method for accepting payments to a DDA according to an embodiment.

### DETAILED DESCRIPTION OF PREFERRED EMBODIMENTS

Embodiments are related to systems and methods for acceptance of payments to a DDA.

Embodiments may facilitate reliance on know your customer (“KYC”) that may be shared among different entities within a financial institution. KYC information may be transmitted in the background, facilitating the acceptance of credit cards an option that may be made available to DDA holders by default. The feature may be available across all channels (e.g., web, mobile, etc.), and credit card information may be collected in a variety of ways (e.g., direct entry, picture with OCR, swiping the card with an attached reader, tapping the card against a NFC chip, etc.).

In one embodiment, the payor may be provided with a receipt for the credit card transaction by, for example, email, SMS, an attached printer, etc.).

In one embodiment, fraud protection mechanisms or other functionality may be provided when using a card issued by the same bank.

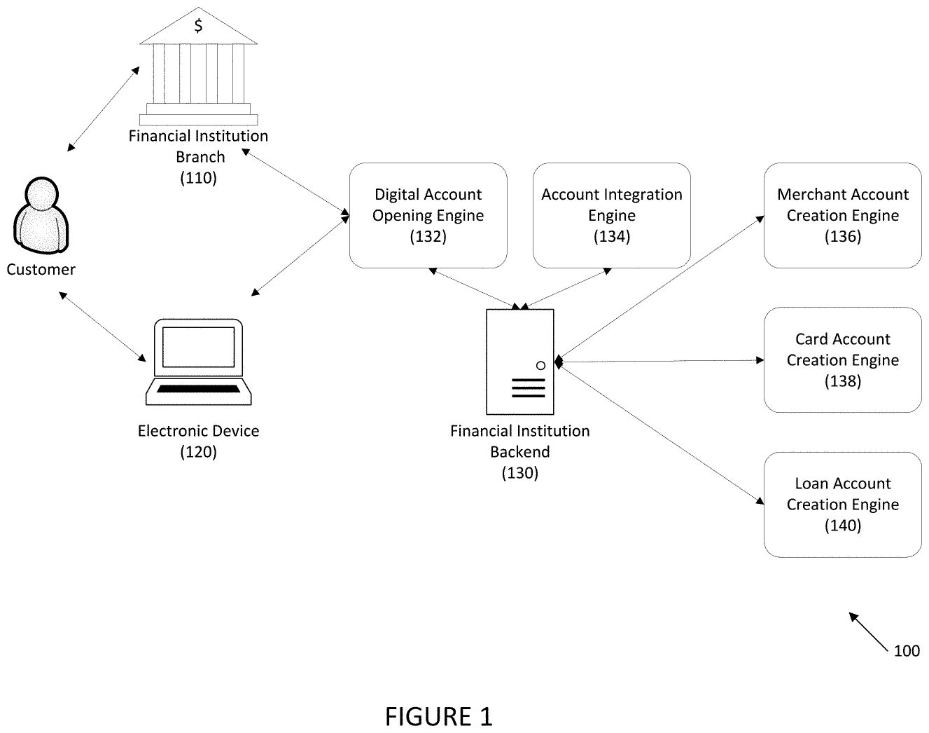

Referring to FIG. 1, a system for digital account opening is disclosed according to an embodiment. System 100 may include a prospective business customer that may access a financial institution's digital account opening engine 132 that may be hosted by a financial institution backend 130. The prospective customer may access digital account opening engine 132 in person at financial institution branch 110 or online using, for example, electronic device 120 to access a website provided by the financial institution.

Electronic device 120 may be any suitable electronic device, including computers (e.g., desktop, laptop, notebook, tablet, etc.), smart phones, Internet of Things (“IoT”) devices, kiosks, terminals, etc.

Digital account opening engine may collect information necessary to open an account for the prospective customer, and may provide the information to account integration engine 134. Account integration engine 134 may cause a plurality of accounts, such as a merchant account, a card account, and a loan account, to be created by merchant account creation engine 136, card account creation engine 138, and loan account creation engine 140, respectively. Other types of account may be created as is necessary and/or desired.

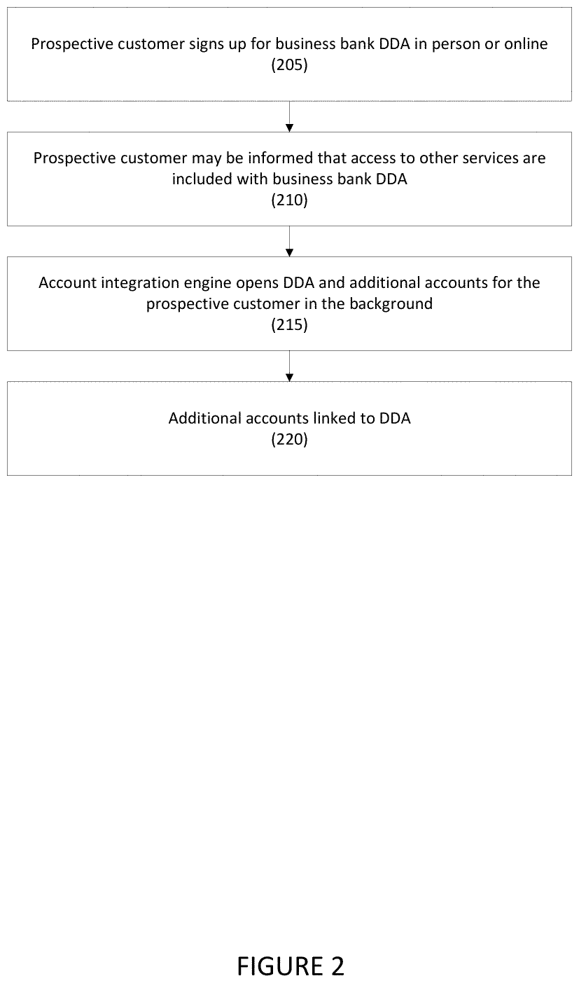

Referring to FIG. 2, a method for digital account opening is disclosed according to an embodiment. In step 205, a prospective business customer may sign up for a business bank DDA either in person at a financial institution branch or online.

In one embodiment, the prospective business customer may see to open a business banking bundle of accounts and services.

For example, the customer may be required to review and accept terms and conditions during the process, and may have his or her identify verified in person or digitally.

Next, in step 210, the prospective customer may be informed that access to other services, such as Merchant Services, Business Card, and Credit products may be included as part of the business banking bundle, or in addition to the DDA. Note that these services and service names are exemplary only, and other services, service names, etc. may be used as is necessary and/or desired.

In one embodiment, the features of those products may be available to the prospect if needed, but there is no requirement that they use them.

Next, in step 215, an account integration engine may open the additional accounts for the prospective customer in the background. As noted above, the accounts may be automatically created, and there is no requirement that the prospective customer use any of the accounts.

In one embodiment, the additional accounts may be inactive until they are used.

The customer may also be enrolled in online banking services for the financial institution.

In step 220, the additional accounts may be linked to the DDA and made available to the customer at natural points in their interactions with the DDA through online experiences, such as a deposit process, a loan process, etc. In one embodiment, the functions may be presented to the customer via an integrated experience in their interactions.

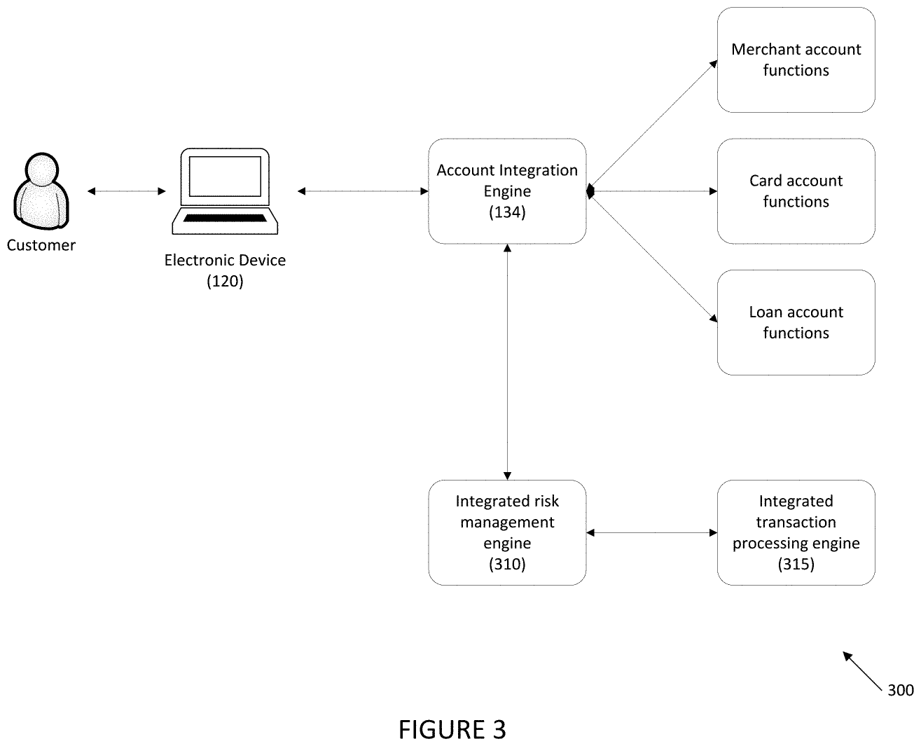

FIG. 3 depicts a system for account management of a business DDA according to one embodiment. System 300 may include a customer of the financial institution accessing accounts using electronic device 120, which may provide access to account integration engine 134 that may be hosted by a server (not shown), such as providing access to merchant account functions, card account functions, and loan account functions.

In embodiments, account integration engine 134 create digital experiences that combine certain features of different underlying financial accounts for the customer.

In one embodiment, integrated transaction processing engine 315 may act as an abstraction layer of underlying money movement, accounts, and/or risk assessments provided by different services of the financial institution (e.g., merchant, card, loan, etc.). The abstraction layer ingests transactional and customer data from each underlying system into a central repository upon which advanced analytics can generate improved risk outcomes and opportunities for those customers.

In one embodiment, integrated transaction processing engine 315 may apply machine learning to identify products, features, and/or functions that meet a customer need based on the abstractions that would otherwise be extremely difficult to identify. Access to additional or other functions may be provided as is necessary and/or desired.

Other sources of data may include clickstream data, internally-generated user insights that may be used to adjust recommendation logic, etc.

Integrated transaction processing engine 315 may integrate the transaction processing of the underlying financial accounts to improve fraud analytics, generate better recommendations for customers, and enable risk-adjusted control of new feature usage by customers.

System 300 may further include integrated risk management engine 310, which may apply rules to the abstractions to identify risk associated with the abstractions. Integrated risk management engine 310 may enforce transaction limits and source data on money movement. For example, account integration engine 134 may set limits or controls on the usage of certain features or accounts based on a risk profile that may be generated based on the customer's transactions and money movement across the financial institution's platforms.

In one embodiment, account integration engine 134 may receive inputs from integrated transaction processing engine 315 and integrated risk management engine 310 and may apply recommendation logic to render appropriate experiences to the customer. For example, account integration engine 134 may determine what functions or features (e.g., Merchant, Card, and/or Loan Account functions and/or features) to make available to the customer, as well as the level of customer engagement with those features (e.g., loan amounts, credit card limits, or merchant processing thresholds).

In one embodiment, the merchant, card, and/or loan account features may be made available to the electronic device 120 through account integration engine 134 via micro-services.

In one embodiment, account integration engine 134 may use machine learning to create new risk rules broadly or at the account level.

Integrated transaction processing engine 315 and integrated risk management engine 310 may supply the same or better fraud screening and account security without same level of rigor up front in sign-up process.

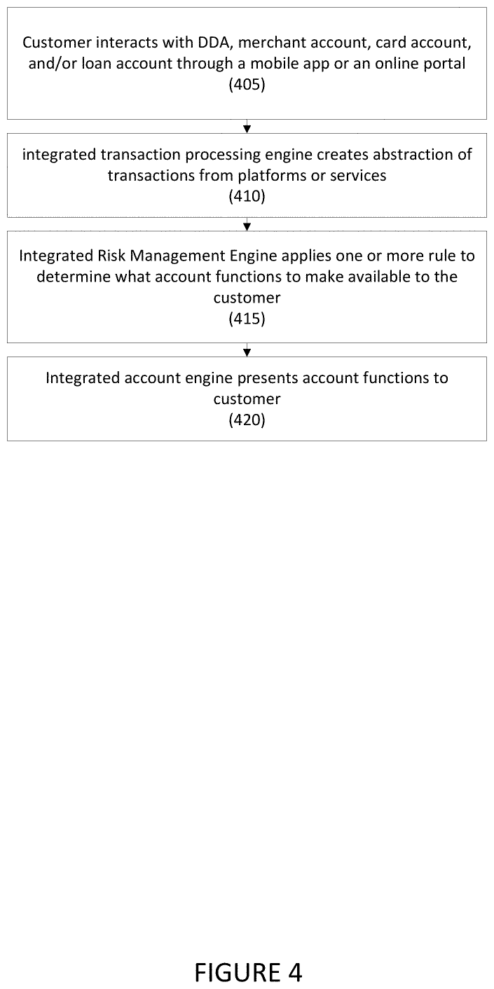

Referring to FIG. 4, a method for account management of a business DDA is provided according to one embodiment.

In step 405, a customer may interact with one or more of a DDA, a merchant account, a card account, and a loan account using, for example, a mobile application, an online portal, etc.

In step 410, an integrated transaction processing engine may interact with multiple platforms or services provided by the financial institution and may generate an abstraction of transactions from each platform or service. An abstraction may represent one or more systems that sources data from multiple underlying systems (e.g., each merchant account, card account, loan account, etc.) so that business logic may be applied across these systems to generate some value for the customer and/or the financial institution.

For example, a customer may enroll in merchant services by clicking a payment acceptance interactive feature, such as a button or similar. Embodiments abstract the merchant services' onboarding by sourcing customer data from a different system and calling enrollment APIs to provision the merchant account and associate it with the DDA into which payments will be deposited.

In step 415, the integrated risk management engine may apply one or more rule to the abstraction to determine the appropriate merchant, card, and/or loan functions to make available to the customer. In one embodiment, the rules may be based on the relationship with the customer, the level of customer involvement, etc.

In step 420, the integrated account engine may receive the identification of account features or functions, and may present the account features or functions to the customer. For example, the functions may be presented on the customer's mobile electronic device, at a website, at an ATM or a kiosk associated with the financial institution, etc.

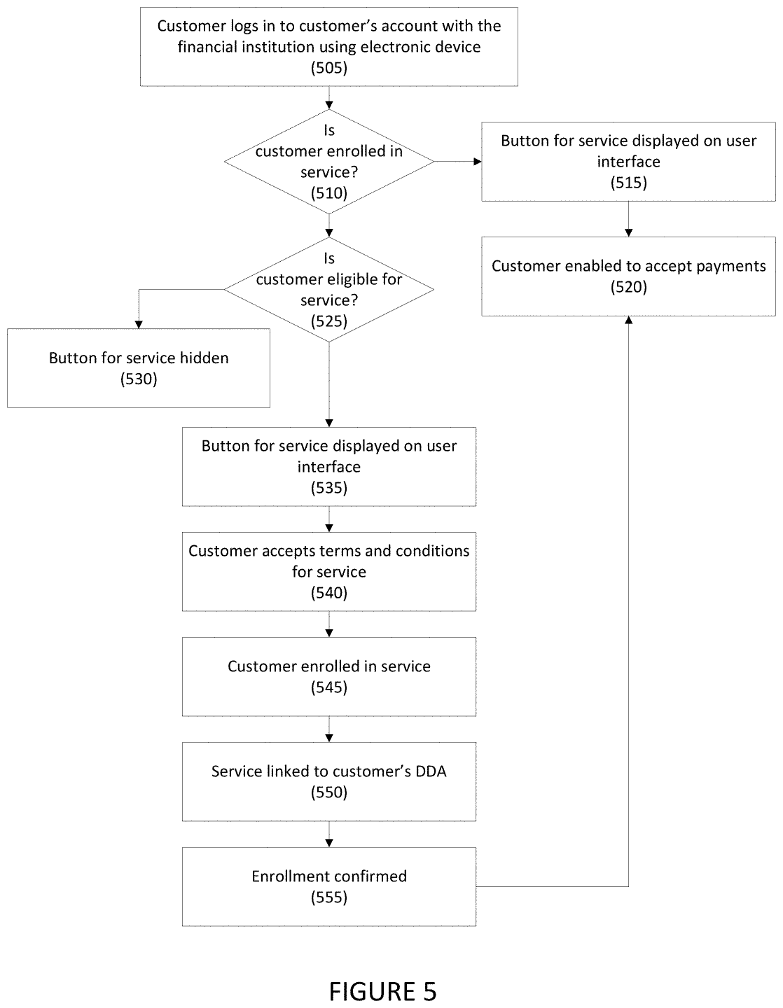

FIG. 5 depicts a method of enrolling a customer in a service to accept payment into the customer's DDA using a card reader to swipe a credit card, receive card information by NFC, etc.

In step 505, the customer may log in to the customer's account with the financial institution, and in step 510, a check may be made to see if the customer is enrolled in the service to accept credit card payment to a DDA. If the customer is enrolled, in step 515, a payment acceptance interactive feature for the service, such as a button or similar interface, may be displayed on the user interface, and in step 520, the customer may accept credit card payments to the customer's DDA.

If the customer is not enrolled, in step 525, a check may be made to see if the customer is eligible for the service. If the customer is not eligible, in step 530, the payment acceptance interactive feature for the service is hidden.

If the customer is eligible, in step 535, the button may be displayed, and if the customer selects the payment acceptance interactive feature, in step 540 the terms and conditions for the service may be displayed. After accepting the terms and conditions, in step 545, the customer may be enrolled in the service. In step 550, the service may be linked to the customer's DDA account using, for example, a digital account opening service.

In step 555, enrollment may be confirmed, and in step 520 the customer may accept credit card payments to the customer's DDA.

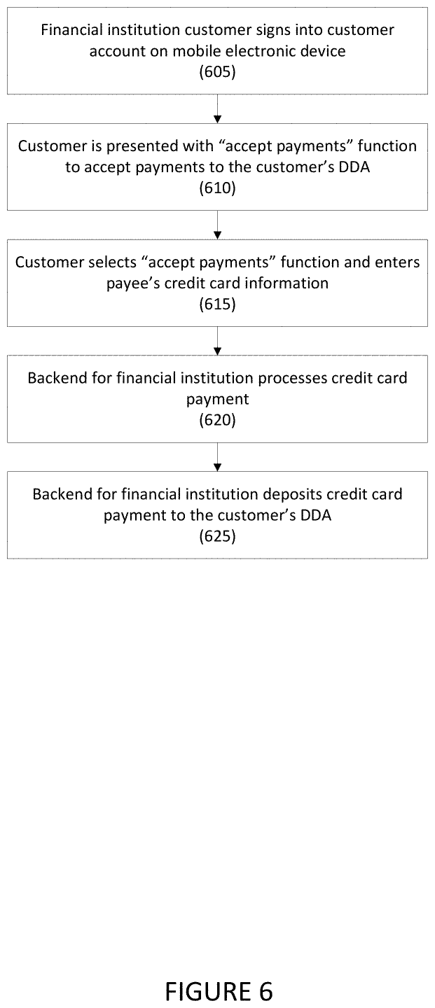

Referring to FIG. 6, a method for accepting payments to a DDA is provided according to an embodiment. For example, credit card processing may be presented with an option to accept card payments within the features and functions offered with the DDA in mobile apps and online experiences. From the customer's perspective, accepting a card payment may be just another means of depositing money to the customer's DDA.

In step 605, a financial institution customer may log into the customer's mobile application.

In step 610, the mobile application may present payment acceptance interactive feature to the customer so the customer can receive credit card payments into the customer's DDA.

In step 615, the customer may select the payment acceptance interactive feature and may enter the payee's credit card information (e.g., account number, expiration date, code, etc. In one embodiment, the customer may enter the credit card number manually; in another embodiment, the customer may read the credit card by swiping the credit card, by scanning the credit card, by NFC, etc.

In one embodiment, the customer may enter at least some of the payee's billing address information, such as the payee's zip code.

In step 620, the backend for the financial institution processes the credit card payment as a business as usual transaction by charging the payee's credit card.

In step 625, the backend for the financial institution deposits the amount of the credit payment to the customer's DDA. The deposit may be available for viewing in the mobile application.

Hereinafter, general aspects of implementation of the embodiments will be described.

Embodiments of the invention or portions of thereof may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for accepting credit card payments at a demand deposit account (DDA), comprising:
in a backend for a financial institution comprising at least one computer processor:
receiving a customer interaction from a mobile application;
determining if the customer is eligible for a credit card accepting service;
causing a payment acceptance interactive feature to be displayed in the mobile application;
enrolling the customer in the credit card accepting service;
linking the credit card accepting service to the customer's DDA; and
causing the mobile application to display an enrollment confirmation message.

2. The method of claim 1, wherein the payment acceptance interactive feature comprises a button.

3. The method of claim 1, further comprising:
receiving, from the mobile application, an indication that the payment acceptance interactive feature was selected;
receiving, from the mobile application, payment information comprising a credit card number and a transaction amount;
processing the payment information; and
depositing the transaction amount to the customer's DDA.

4. The method of claim 3, wherein the credit card number is received as an image.

5. The method of claim 3, wherein the credit card number is received as an electronic file.

6. A method for integrated account opening, comprising:
in an information processing apparatus comprising at least one computer processor:
receiving, from a prospective customer, a request to open a demand deposit account (DDA);
opening the DDA;
opening a non-DDA account for the prospective customer;
linking the non-DDA account to the DDA account; and
presenting information for the DDA and the non-DDA account in a mobile application.

7. The method of claim 6, further comprising:
verifying an identity of the customer.

8. The method of claim 6, wherein the non-DDA account is inactive until it is used.

9. The method of claim 6, wherein the non-DDA account comprises a merchant services account, a business card account, or a credit product.

10. The method of claim 6, wherein the non-DDA account is opened in the background.

11. The method of claim 6, wherein the non-DDA account is made available to the customer during an interaction with the DDA.

12. The method of claim 11, wherein the interaction is a deposit process.

13. The method of claim 6, wherein a type of non-DDA account is identified by machine learning.

14. A method for integrated account management, comprising:
in an information processing apparatus comprising at least one computer processor:
receiving, from an online portal, a customer interaction with one of a plurality of customer accounts, the customer account integrated with each other;
generating an abstraction for transactions involving each account from a plurality of systems;
applying a rule to identify a feature to make available to the customer; and
presenting the feature to the customer in the online portal.

15. The method of claim 14, wherein two of the plurality of accounts are serviced by different backend systems.

16. The method of claim 14, wherein the transactions comprise at least one an underlying money movement, an underlying account, and a risk assessment.

17. The method of claim 14, further comprising:
applying machine learning to the abstractions to identify a product, feature, or function to make available to the customer.

18. The method of claim 14, wherein the machine learning is further applied to customer clickstream data.

19. The method of claim 14, further comprising:
assessing a customer risk by applying a risk rule to the abstractions.

20. The method of claim 19, further comprising:
enforcing a transaction limit on a money movement based on the risk assessment.
